(19) United States
(12) Patent Application Publication
(10) Pub. No.: US 2023/0206040 A1
(43) Pub. Date: Jun. 29, 2023

(54) COLLABORATIVE MONITORING OF INDUSTRIAL SYSTEMS

(71) Applicant: International Business Machines Corporation, Armonk, NY (US)

(72) Inventors: Amadou Ba, Navan (IE); Fearghal O'Donncha, Aran Islands (IE); FABIO LORENZI, Tyrrelstown (IE)

(21) Appl. No.: 17/560,403

(22) Filed: Dec. 23, 2021

(51) Int. Cl. G06N 3/063; G06N 3/04; G06K 9/62

(52) U.S. Cl. CPC G06N 3/063; G06N 3/0454; G06K 9/6257

(57) ABSTRACT

A processor may collect data from each of two or more stations of a set of stations. The processor may determine a subset of the set of stations that are related. The processor may monitor a residual for a machine learning model for each station in the subset of stations. The processor may detect a change in the operation of a first station of the subset of stations.

### BACKGROUND

The present disclosure relates generally to the field of production/industrial plant monitoring, and more specifically to determining the operational status of a station in an industrial setting.

The detection of anomalies in the operational status of stations in a production/industrial plant at the earlier stage is of great importance.

### SUMMARY

Embodiments of the present disclosure include a method, computer program product, and system for determining the operational status of a station in an industrial setting. A processor may collect data from each of two or more stations of a set of stations. The processor may determine a subset of the set of stations that are related. The processor may monitor a residual for a machine learning model for each station in the subset of stations. The processor may detect a change in the operation of a first station of the subset of stations.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an exemplary system for determining the operational status of a station, in accordance with aspects of the present disclosure.

FIG. 2A is a flowchart of an exemplary method for determining the operational status of a station, in accordance with aspects of the present disclosure.

FIG. 2B is a flowchart of an exemplary method for determining the operational status of a station, in accordance with aspects of the present disclosure.

FIG. 2C is a flowchart of an exemplary method for determining the operational status of a station, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of production/industrial plant monitoring, and more specifically to determining the operational status of a station in an industrial setting. While the present disclosure is not necessarily limited to such applications, various aspects of the disclosure may be appreciated through a discussion of various examples using this context.

In some embodiments, the disclosed method may allow for monitoring of a station in a manufacturing/industrial setting (e.g., manufacturing line in a manufacturing plant) by exploiting the strength of an adjacency matrix. In some embodiments, the time to anomaly detection may be reduced through collaboration between adjacent nodes (e.g., different stations in the manufacturing plant). In some embodiments, implementation of early corrective measures may be allowed as a result of anomaly detection. In some embodiments, by combining machine learning with a learned or user-provided topology of the industrial setting and machine/sensor distribution, a more scalable and flexible collaborative monitoring of the station and associated diagnostics of deviations may be possible.

In some embodiments, the disclosed methods may allow for determination of the operational status of a station or entity in a production plant or industrial/manufacturing setting. In some embodiments, the status of the station may be known based on information from other stations (e.g., stations in the same production plant or manufacturing/industrial system) that have similar or the same dynamics.

In some embodiments, a processor may collect data from each of two or more stations of a set of stations. In some embodiments, the data may be sensor data (e.g., from IoT systems, cameras, thermal sensors, etc.) that reflects the performance or operation of the stations. In some embodiments, the processor may determine a subset of the set of stations that are related. In some embodiments, the processor may determine which stations are related using collaborative learning. In some embodiments, the collaborative learning approach may be any computer aided approach that enables identification of a subset of the set of stations as having the same or similar operational or performance dynamics. For example, robots in manufacturing settings performing the same tasks and having the same sensors recording the same measurements can collaborate in terms of monitoring, as some of the robots may have experienced anomalies that can help anticipate the same anomalies that might occur to others.

In some embodiments, the subset of stations that are related may be identified based on user input regarding the type of work, location, step in a process, etc. that the stations are used to perform. For example, a subset of stations may be used to manufacture a product, where each station performs a consecutive step in the manufacturing of the product. In some embodiments, the subset of the set of stations that are related (e.g., having similar operational outcomes, behaviors, characteristics) may be determined based on operational or performance metrics of the stations obtained from historical operation of the stations.

In some embodiments, the processor may determine the subset of the set of stations that are related utilizing a machine learning model. In some embodiments, the machine learning model may include a graph convolutional neural network (“GCNN”). In some embodiments, the GCNN may be utilized to determine an adjacency matrix.

In some embodiments, the machine learning model may include a graphical machine learning model that can determine similarities between similar dynamics at various stations/entities/nodes and exploit those dynamics to build the adjacency matrix. In some embodiments, the machine learning model may include a GCNN to diagnose performance degradation by relying on similar behaviors having potentially occurred at other stations/entities/nodes. In some embodiments, by using a GCNN, a recursive neighborhood aggregation, where each entity aggregates feature vectors of its neighbors to compute its own new feature vector, may be adopted.

In some embodiments, the adjacency matrix may include a representation of the physical constraints in the physical system (e.g., machinery operating in a system/setting) in the neural network. In some embodiments, the adjacency matrix representation may take into account the interrelations between the various entities/nodes of the physical system. In some embodiments, the adjacency matrix may represent what nodes/entities/stations in the system/setting are connected and have similar dynamics/behaviors/characteristics.

In some embodiments, determining the subset of stations that are related may include identifying the subset of the set of stations that have similar operational dynamics. In some embodiments, determining the subset of stations that are related may include determining, utilizing historical data regarding the subset of stations, operational metrics associated with performance of the subset of stations._For example, a machine learning model or an artificial intelligence model may be utilized to determine which stations have related operational dynamics (e.g., two stations in the factory may be used to manufacture the subcomponents of the same category and therefore rely on the same factory equipment to be operating properly) from historical data. The historical data may also be utilized to determine operational metrics (e.g., number of subcomponents made per time unit, time required for making each subcomponent, amount of waste created by the station, etc.) associated with performance of the station under various conditions (e.g., working correct, working incorrectly, working with partially degraded performance, etc.).

In some embodiments, the processor may monitor a residual for a machine learning model for each station in the subset of stations. In some embodiments, the processor may detect a change in the operation of a first station of the subset of stations. In some embodiments, each station may have a machine learning model that assesses the operation and/or performance of the station locally on an edge computing device. In some embodiments, the processors may take the difference between an observed data value and a predicted data value for each station. In some embodiments, if the residual value deviates from zero for a particular station, the processor may detect a change in the operation of the particular station (e.g., the first station of the subset of stations). In some embodiments, the machine learning model may detect performance issues at a target node (e.g., first station or entity in the manufacturing/industrial/factory system) based on historical information regarding the performance and operation of other nodes in the setting (e.g., stations in the subset).

In some embodiments, detecting a change in the operation of a first station of the subset of stations may involve using change point detection. For example, change point detection may be performed as part of time series analysis to identify an abrupt and/or significant change in the data generating process. In some embodiments, the processor may output a notification that the particular station is having performance issues. In some embodiments, the processor may output the notification to a user, a computer, a mobile computing device, an advanced user interface, augmented reality glasses, a wearable device, etc. In some embodiments, the processor may forecast the operational status of the particular station by enriching and improving the performance of monitoring across stations/nodes.

In some embodiments, the processor may further identify that a first residual for the first station is deviating from zero. In some embodiments, the processor may adjust tuning parameters for a first machine learning model associated with the first station. In some embodiments, distributed analytics on top of graphs may be utilized for collaborative monitoring and real-time detection of performance degradation. In some embodiments, the parameters for each model may be adjusted during the detection of a change in operation/anomaly of a station. In some embodiments, the parameters for the machine learning model may be tailored for the station being monitored. In some embodiments, the processor may detect a change in the operation of a second station of the subset of stations. In some embodiments, the processor may identify that a second residual associated with the second station is deviating from zero. In some embodiments, the processor may adjust tuning parameters for a second machine learning model associated with the second station.

In some embodiments, the first machine learning model may be operated by an edge computing device. In some embodiments, each machine learning model for each station in the subset of stations may operate by edge computing devices in proximity to their respective stations. In some embodiments, edge analytics at the stations level may be able to operate with an embedded GCNN (e.g., for scoring).

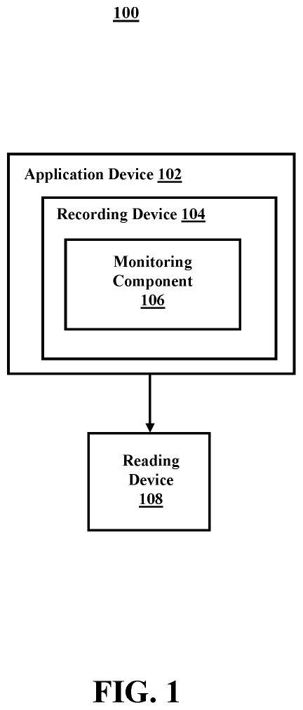

Referring now to FIG. 1, a block diagram of a system 100 for determining the operational status of a station is illustrated. System 100 includes an application device 102 and reading device 108. The reading device 108 is configured to be in communication with the application device 102. The application device 102 includes a recording device 104 and a monitoring component 106. In some embodiments, the reading device 108 and the application device 102 may be any devices that contain a processor configured to perform one or more of the functions or steps described in this disclosure.

In some embodiments, the recording device records data (e.g., sensor data) collected from a set of stations in an industrial/manufacturing/factory setting or system. In some embodiments, the recording device performs semantic mapping and integration. In some embodiments, the recording device predicts the performance of the stations (e.g., identifies a subset of the stations that are related), on a station by station basis. In some embodiments, the recording device inspects the residuals (e.g., a residual for a machine learning model for each station in the subset of stations). In some embodiments, the recording device detects performance degradation (e.g., a change in the operation of a first station of the subset of stations).

In some embodiments, the monitoring component 106 of the recording device 104 may perform data processing (e.g., cleaning and curation). In some embodiments, the monitoring component 106 may determine the subset of the set of stations (adjacency matrix) to be considered for learning. In some embodiments, the monitoring component 106 may learn the parameters of the machine learning models of the stations. In some embodiments, the monitoring component 106 may perform change-point detection (e.g., Bayesian/hypothesis testing).

In some embodiments, the application device may send the results of the monitoring (e.g., a change in the operation of a first station) to the reading device. In some embodiments, the reading device may include: a computer, a mobile computing device, an advanced user interface, augmented reality glasses, a wearable device, etc.

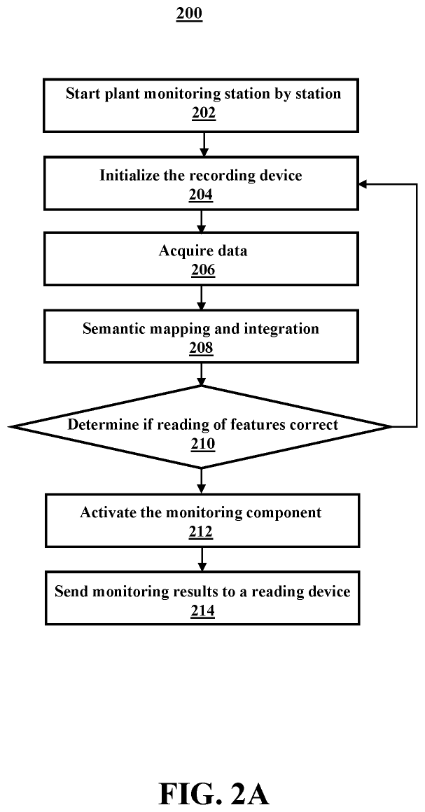

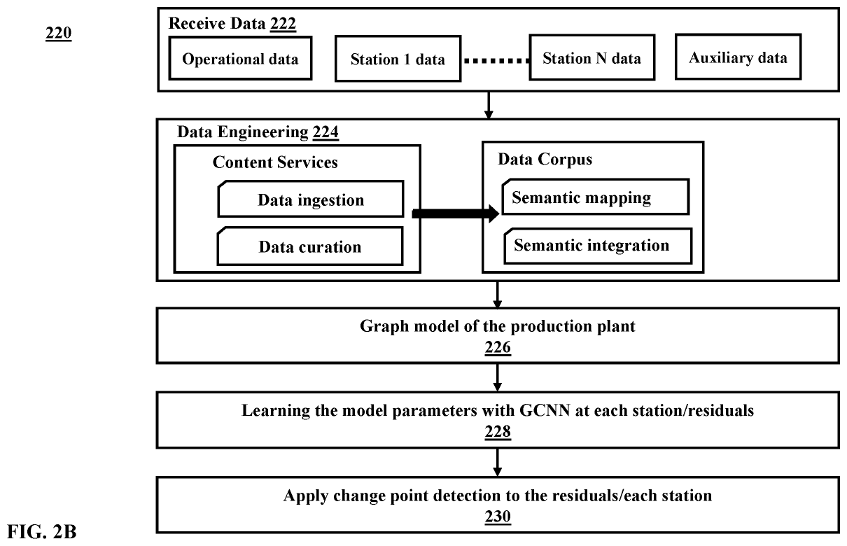

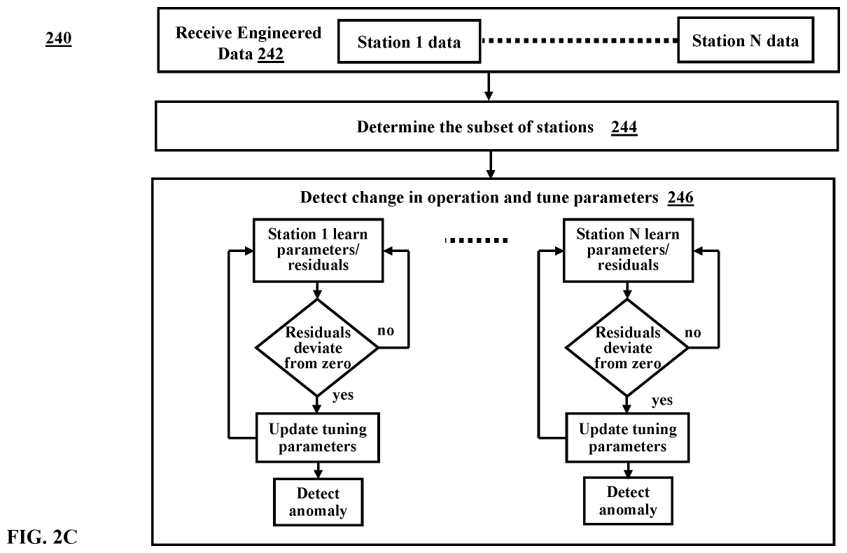

Referring now to FIG. 2A, illustrated is a flowchart of an exemplary method 200 for determining the operational status of a station, in accordance with embodiments of the present disclosure. In some embodiments, a processor of a system may perform the operations of the method 200. In some embodiments, method 200 begins at operation 202. At operation 202, monitoring of the plant (e.g., by the recording device 104 of system 100, shown in FIG. 1), station by stations, begins. In some embodiments, method 200 proceeds to operation 204, where a recording device is initialized. In some embodiments, method 200 proceeds to operation 206. At operation 206, data is acquired from the stations. In some embodiments, method 200 proceeds to operation 208, where the processor performs semantic mapping and integration. In some embodiments, method 200 proceeds to operation 210, where the processor determines if the reading of the features is correct. In some embodiments, if the reading of the features is not correct, the process returns to operation 212 where the recording device is initialized, and new data is acquired. In some embodiments, if the reading of the features is correct, the monitoring component (e.g., monitoring component 106 of system 100, shown in FIG. 1) is activated at operation 212. In some embodiments, method 200 proceeds to operation 214, where the processor, in case an anomaly is detected, sends the monitoring results to a reading device (e.g., reading device 108 of system 100, shown in FIG. 1).

As discussed in more detail herein, it is contemplated that some or all of the operations of the method 200 may be performed in alternative orders or may not be performed at all; furthermore, multiple operations may occur at the same time or as an internal part of a larger process.

Referring now to FIG. 2B, illustrated is a flowchart of an exemplary method 220 for determining the operational status of a station, in accordance with embodiments of the present disclosure. In some embodiments, a processor of a system (e.g., system 100, shown in FIG. 1) may perform the operations of the method 220. In some embodiments, method 220 begins at operation 222. At operation 222, a processor receives data. In some embodiments, the data received may include: operational data (e.g., information related to the products being manufactured in a production plant), auxiliary data (e.g., weather related information), and data regarding stations 1-N (e.g., sensor data detecting operational characteristics/performance characteristics at stations 1-N).

In some embodiments, method 220 proceeds to operation 224, where the processor engages in data engineering. In some embodiments, the data engineering may include: data ingestion, data curation (e.g., detecting missing values and outliers and compensating for them by using a median filter, or any other interpolation method. Data curation may also include downsampling, upsampling time series for correlation purposes, etc.), semantic mapping (e.g., an approach allowing semantic relationships to be made explicit via ontologies), and semantic integration (e.g., using the semantically mapped data to combine the data coming from various sources to provide a unified view capable of easing the exploitation).

In some embodiments, method 220 proceeds to operation 226, where the processor graphs a model of the production plant. In some embodiments, method 220 proceeds to operation 228, where the processor learns the model parameters utilizing a GCNN model at each station. In some embodiments, method 220 proceeds to operation 230, where the processor applies change point detection to detect changes to the residuals (e.g., difference between sensor value during current operation and sensor value during standard operation).

As discussed in more detail herein, it is contemplated that some or all of the operations of the method 220 may be performed in alternative orders or may not be performed at all; furthermore, multiple operations may occur at the same time or as an internal part of a larger process.

Referring now to FIG. 2C, illustrated is a flowchart of an exemplary method 240 for determining the operational status of a station, in accordance with embodiments of the present disclosure. In some embodiments, a processor of a system (e.g., system 100, shown in FIG. 1) may perform the operations of the method 240. In some embodiments, method 240 begins at operation 242. At operation 242, a processor (e.g., of monitoring component 106, shown in FIG. 1) receives engineered data. In some embodiments, the engineered data may include data from station 1, station 2, station 3, etc. through station N. In some embodiments, method 240 proceeds to operation 244, where the processor determines the adjacency matrix/the subset of stations to be considered.

In some embodiments, method 240 proceeds to operation 246, where the processor detects a change in operation of each/any of stations 1 through station N and tunes parameters for each/any of stations 1 through station N. In some embodiments, the processor learns the parameters/residuals for the first station and/or the station N of the subset of stations specified by the adjacency matrix. In some embodiments, if the residual (e.g., the difference between the values for standard operation of the station and the values for the current operation of the station) deviates from zero, the tuning parameters for the machine learning model associated with station 1 and/or station N are updated, and an anomaly is detected. In some embodiments, if the residual does not deviate from zero, the tuning parameters are not updated. In some embodiments, when the residuals for station 1 and/or station N start to deviate from zero again, the tuning parameters for station 1 and/or station N are updated. In some embodiments, parameters may be learned for each of stations 1 through N. In some embodiments, each of stations 1 through N may be monitored to determine when their residuals start to deviate from zero. In some embodiments, if any of their residuals start to deviate from zero, their tuning parameters are updated, and the stations continue to be monitored for deviations from zero of their residuals.

As discussed in more detail herein, it is contemplated that some or all of the operations of the method 240 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

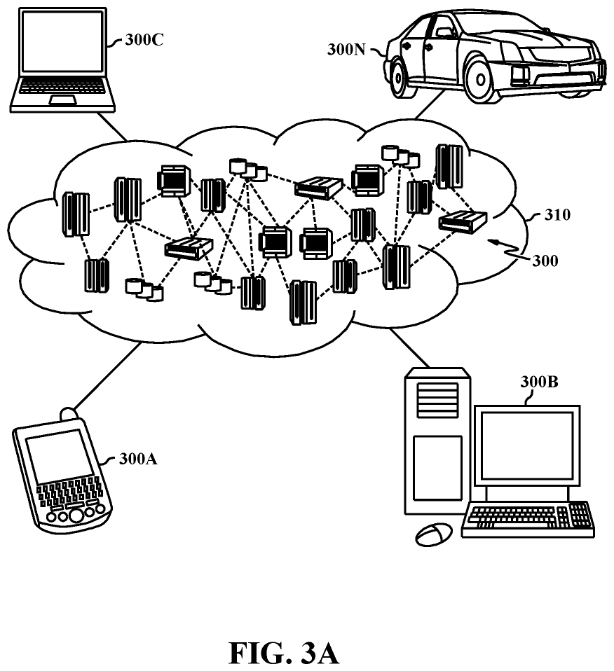

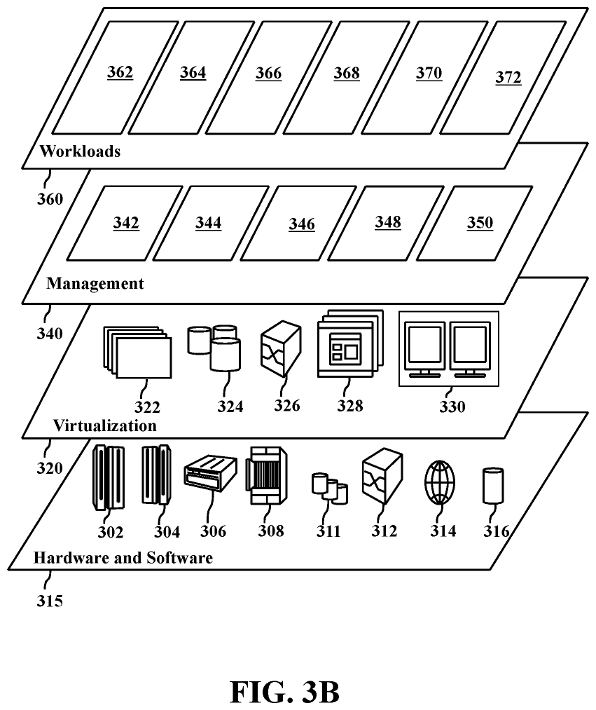

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and determining the operational status of a station 372.

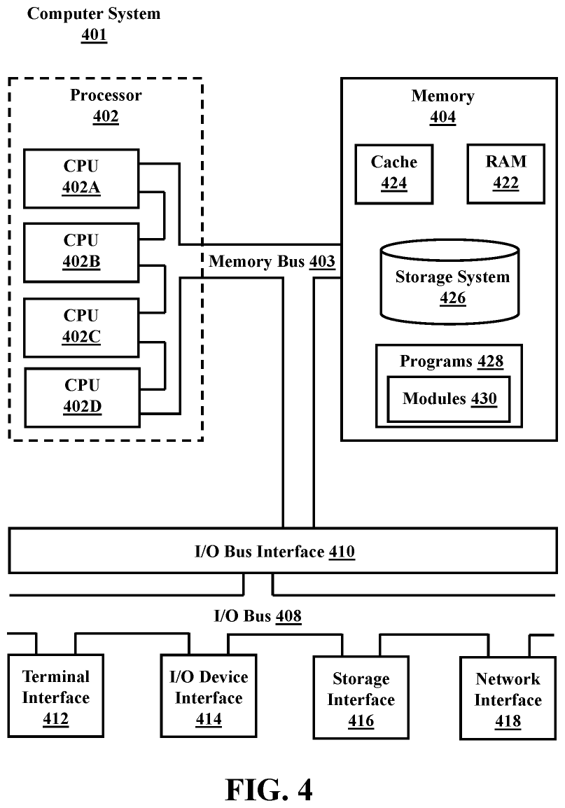

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.”

Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both.

Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method for determine the operational status of a station, the method comprising:
collecting, by a processor, data from each of two or more stations of a set of stations;
determining a subset of the set of stations that are related;
monitoring a residual for a machine learning model for each station in the subset of stations; and
detecting a change in the operation of a first station of the subset of stations.

2. The computer-implemented method of claim 1, wherein determining the subset of stations that are related includes:
identifying the subset of the set of stations that have similar operational dynamics; and
determining, utilizing historical data regarding the subset of stations, operational metrics associated with performance of the subset of stations.

3. The computer-implemented method of claim 1, wherein determining a subset of the set of stations that are related includes utilizing a graph convolutional neural network to determine an adjacency matrix.

4. The computer-implemented method of claim 1, wherein detecting a change in the operation of a first station of the subset of stations includes using change point detection.

5. The computer-implemented method of claim 1, further comprising:
identifying that a first residual for the first station is deviating from zero; and
adjusting tuning parameters for a first machine learning model associated with the first station.

6. The computer-implemented method of claim 5, further comprising:
detecting a change in the operation of a second station of the subset of stations;
identifying that a second residual associated with the second station is deviating from zero; and
adjusting tuning parameters for a second machine learning model associated with the second station.

7. The computer-implemented method of claim 5, wherein the first machine learning model is operated by an edge computing device.

8. A system comprising:
a memory; and
a processor in communication with the memory, the processor being configured to perform operations comprising:
collecting data from each of two or more stations of a set of stations;
determining a subset of the set of stations that are related;
monitoring a residual for a machine learning model for each station in the subset of stations; and
detecting a change in the operation of a first station of the subset of stations.

9. The system of claim 8, wherein determining the subset of stations that are related includes:
identifying the subset of the set of stations that have similar operational dynamics; and
determining, utilizing historical data regarding the subset of stations, operational metrics associated with performance of the subset of stations.

10. The system of claim 8, wherein determining a subset of the set of stations that are related includes utilizing a graph convolutional neural network to determine an adjacency matrix.

11. The system of claim 8, wherein detecting a change in the operation of a first station of the subset of stations includes using change point detection.

12. The system of claim 8, the processor being configured to perform further operations comprising:
identifying that a first residual for the first station is deviating from zero; and
adjusting tuning parameters for a first machine learning model associated with the first station.

13. The system of claim 12, the processor being configured to perform further operations comprising:
detecting a change in the operation of a second station of the subset of stations;
identifying that a second residual associated with the second station is deviating from zero; and
adjusting tuning parameters for a second machine learning model associated with the second station.

14. The system of claim 12, wherein the first machine learning model is operated by an edge computing device.

15. A computer program product comprising a computer readable storage medium having program instructions embodied therewith, the program instructions executable by a processor to cause the processor to perform operations, the operations comprising:
collecting data from each of two or more stations of a set of stations;
determining a subset of the set of stations that are related;
monitoring a residual for a machine learning model for each station in the subset of stations; and
detecting a change in the operation of a first station of the subset of stations.

16. The computer program product of claim 15, wherein determining the subset of stations that are related includes:
identifying the subset of the set of stations that have similar operational dynamics; and
determining, utilizing historical data regarding the subset of stations, operational metrics associated with performance of the subset of stations.

17. The computer program product of claim 15, wherein determining a subset of the set of stations that are related includes utilizing a graph convolutional neural network to determine an adjacency matrix.

18. The computer program product of claim 15, wherein detecting a change in the operation of a first station of the subset of stations includes using change point detection.

19. The computer program product of claim 15, the processor being configured to perform further operations comprising:
identifying that a first residual for the first station is deviating from zero; and
adjusting tuning parameters for a first machine learning model associated with the first station.

20. The computer program product of claim 15, the processor being configured to perform further operations comprising:
detecting a change in the operation of a second station of the subset of stations;
identifying that a second residual associated with the second station is deviating from zero; and
adjusting tuning parameters for a second machine learning model associated with the second station.
